(19) United States
(12) Patent Application Publication
(10) Pub. No.: US 2026/0057263 A1
(43) Pub. Date: Feb. 26, 2026

(54) SYSTEMS AND METHODS FOR AUTOREGRESSIVE INFERENCE

(71) Applicant: Cerebras Systems Inc., Sunnyvale, CA (US)

(72) Inventors: Michael Edwin JAMES, San Carlos, CA (US); Sean LIE, Los Altos, CA (US); Vladimir KIBARDIN, Palo Alto, CA (US)

(21) Appl. No.: 19/307,690

(22) Filed: Aug. 22, 2025

Related U.S. Application Data
(60) Provisional application No. 63/686,711, filed on Aug. 23, 2024.

(51) Int. Cl. G06N 5/04

(52) U.S. Cl. CPC G06N 5/04

(57) ABSTRACT

The present disclosure includes systems and methods for autoregressive inference using one or more compute accelerators. A method includes configuring one or more compute accelerators to implement a processing sequence of a machine learning (ML) model, wherein the ML model includes a plurality of model layers, and wherein the configuring includes mapping, based at least in part on the processing sequence, the plurality of model layers to a plurality of processing regions of the one or more compute accelerators and arranging connections between the plurality of processing regions to form a processing pipeline corresponding to the processing sequence. The method includes, based at least in part on receiving one or more queries, processing, using the ML model, the one or more queries through the processing pipeline.

### CROSS-REFERENCE TO RELATED APPLICATIONS

This application claims the benefit of U.S. Provisional Patent Application No. 63/686,711, filed Aug. 23, 2024, which is incorporated by reference herein in its entirety.

### TECHNICAL FIELD

The present disclosure relates to inference using one or more compute accelerators. In particular, the present disclosure describes one or more embodiments including configuring a pipeline execution model and mapping one or more processing regions of the one or more compute accelerators to stages of the pipeline execution model.

### SUMMARY

Autoregressive inference is challenging at least in part because the execution architecture typically has an inherently serial structure that interferes with achieving high performance, low latency, and high throughput. For example, an output from processing a first token can influence values of subsequently processed tokens such that the computational accuracy for the first token may propagate to the accuracy of the subsequent tokens. Generating high-quality (e.g., high predictive accuracy) responses in autoregressive inference may include complex, time-consuming computations where each token is processed through the model and may involve numerous read/write operations from off-site memory at each stage of processing the model layers of a machine learning (ML) model. Memory bandwidth using off-site memory limits the processing performance and undesirably increases the processing time.

Some approaches distribute the processing of each token among a plurality of computing units (e.g., graphical processing units and associated memory) organized as a computing cluster but are limited, for example, by sequential processing in autoregressive inference and physical hardware (e.g., memory bandwidth, number of available communication paths between processors and memory, available memory per computing unit, etc.).

Furthermore, it is a challenge to balance speed and accuracy in such approaches, by, for example, generating faster responses after simplifying the computations, which undesirably compromises the quality (e.g., accuracy) of the output.

Accordingly, there is a need for improving the execution architecture involved in autoregressive inference.

The present disclosure describes autoregressive inference using one or more compute accelerators (e.g., one or more deep learning accelerators (DLAs)) arranged as a pipeline execution model that may include a near-compute memory architecture (e.g., memory located on the same integrated circuit or chip as the compute, memory located proximate to the site of compute, processing elements (PEs) on the same substrate with each PE including a respective memory element, etc.).

Model layers are generally sequentially dependent. For example, for an input token, each model layer may be computed sequentially based on a preceding layer's output. One or more output tokens may be selected and may be referred to as generated text. The generated text may be iterated through the pipeline with updated model data (e.g., an updated key-value database) using the output token (e.g., generated text) as input. In some aspects, the near-compute memory architecture provides sufficient memory bandwidth (e.g., comparable to on-chip memory bandwidth) that does not limit processing performance and reduces the processing time for executing an ML model. Some examples of ML models include Fully Connected Neural Networks (FCNNs), Recurrent Neural Networks (RNNs), Convolutional Neural Networks (CNNs), Long Short-Term Memory (LSTM) networks, autoencoders, deep belief networks, generative adversarial networks, generative transformer (GPT) or other transformer-based model, etc., combinations thereof, and/or variants thereof. For example, the pipeline execution model may include a plurality of stages corresponding to a processing sequence of an ML model (e.g., following a sequence of model layers), and sufficient memory is available at each stage to store most or all of the model data near the site of compute for rapid retrieval. For example, layers of the ML model may be assigned to regions of PEs and arranged such that data packets for a subsequent pipeline stage may be retrieved from adjacent regions. In some beneficial aspects, the distance between the regions of processing elements, the communication path length, and the latency between regions are reduced as the data packets are processed by stages of the pipeline. For example, processing elements may be configured as localized decoder(s) as part of a pipeline execution model, where most or all data for executing an ML model is stored locally to the decoder(s).

As an illustrative example, a neural network processes data according to a dataflow sequence comprising layers of neurons. Stimuli (e.g., input data) may be received by an input layer of neurons and the computed results of the dataflow sequence (e.g., output data) are provided by an output layer of neurons. Example layers of neurons include input layers, output layers, rectified linear unit layers, fully connected layers, recurrent layers, long short-term memory layers, self-attention layers, convolutional layers, kernel layers, dropout layers, and pooling layers. A neural network may be conditionally and/or selectively trained, subject to hardware acceleration. After being trained, a neural network is conditionally and/or selectively used for inference, subject to hardware acceleration.

Some beneficial aspects of the pipeline execution model described herein include increasing (e.g., maximizing) single-stream data packet throughput, increasing (e.g., maximizing) multi-stream data packet throughput, decreasing (e.g., minimizing) single-packet processing latency, and increasing concurrent processing of a plurality of data packet streams (e.g., streams of one or more sequences of tokens). In some beneficial aspects, the PEs (e.g., compute and/or memory elements) are communicatively coupled such that the memory bandwidth matches the bandwidth of the PEs determined by the wiring density between the memory and compute elements.

In some embodiments, a method includes configuring one or more compute accelerators to implement a processing sequence of an ML model, wherein the ML model may include a plurality of model layers. In some embodiments, configuring the one or more compute accelerators may include mapping, based at least in part on the processing sequence, the plurality of model layers to a plurality of processing regions of the one or more compute accelerators and arranging connections between the plurality of processing regions to form a processing pipeline corresponding to the processing sequence. The method may include, based at least in part on receiving one or more queries, processing, using the ML model, the one or more queries through the processing pipeline.

In some embodiments, a system includes one or more one or more compute accelerators including a plurality of processing regions and processing circuitry to configure the one or more compute accelerators to implement a processing sequence of a ML model, wherein the ML model may include a plurality of model layers. In some embodiments, the processing circuitry is to configure the one or more compute accelerators including mapping, based at least in part on the processing sequence, the plurality of model layers to a plurality of processing regions of the one or more compute accelerators and arranging connections between the plurality of processing regions to form a processing pipeline corresponding to the processing sequence. The processing circuitry is further to, based at least in part on receiving one or more queries, process, using the ML model, the one or more queries through the processing pipeline.

In some embodiments, a non-transitory computer-readable medium stores one or more instructions that, when executed by processing circuitry, cause the processing circuitry to configure one or more compute accelerators to implement a processing sequence of a ML model, wherein the ML model comprises a plurality of model layers. In some embodiments, the one or more instructions may cause the processing circuitry to configure the one or more compute accelerators including mapping, based at least in part on the processing sequence, the plurality of model layers to a plurality of processing regions of the one or more compute accelerators and arranging connections between the plurality of processing regions to form a processing pipeline corresponding to the processing sequence. The processing circuitry is further to, based at least in part on receiving one or more queries, process, using the ML model, the one or more queries through the processing pipeline.

In some embodiments, each processing region of the plurality of processing regions may include a respective plurality of processing elements. Each processing element of the respective plurality of processing elements may include one or more compute elements and memory positioned proximate to the one or more compute elements. As an illustrative example, one or more compute accelerators may include PEs that are arranged in regions for processing data. In some embodiments, each PE includes respective local memory for storing output from the processing. In some embodiments, a first portion of PEs in each region is to be allocated for compute (e.g., contributes to the computation(s)), a second portion of the PEs is to be allocated for storage (e.g., as cache memory), and a third portion of the PEs is to be allocated for routing (e.g., delivering data from storage to compute). Each model layer may be assigned to at least one region of PEs. For example, one or more PEs (e.g., compute PEs) at a first region may be configured to perform one or more compute operations (e.g., multiply-accumulate, multiply-add, fused multiply-accumulate, etc.) based on the model layer. In this example, a sequence of tokens may be processed at each region by performing the one or more compute operations at the processing elements in the region. After processing at a first region, model data (e.g., key-value (KV) data) from the processing is stored in local memory (e.g., memory of each PE, cache memory, at storage PEs, etc.). The model data may be retrieved (e.g., via routing PEs) for subsequent processing of the tokens at PEs of a second region. Each processing region may retrieve model data from the processing of any token in the sequence of tokens.

In some embodiments, the processing elements may be coupled via a unifying compute fabric (“fabric” henceforth) and enabled to communicate with each other via fabric elements of the fabric. The processing elements and the fabric may be collectively referred to as a fabric of processing elements on one or more compute accelerators (e.g., a single compute accelerator, a plurality of compute accelerators coupled to each other). In some embodiments, the one or more compute accelerators may include a fabric, wherein the fabric is to connect processing elements of the plurality of processing regions. Arranging the connections may include arranging fabric elements of the fabric to connect adjacent processing elements of the plurality of processing regions. In some embodiments, each processing element of the respective plurality of processing elements may include a fabric router coupled to the fabric.

In some embodiments, each processing element of the respective plurality of processing elements includes a router, wherein respective routers of adjacent processing elements are connected via one or more wiring elements between the respective routers. Arranging the connections may include forming, using the one or more wiring elements between the respective routers, one or more paths between a first processing element of a first processing region and a second processing element of a second processing region. Each router may include one or more ports, and the one or more wiring elements may connect respective ports of the respective routers. In some embodiments, the first processing element and the second processing element are not adjacent to each other. For example, one or more processing elements may be disposed between the first processing element and the second processing element. In some embodiments, the first processing element may be adjacent to the second processing element.

In some embodiments, a first compute accelerator, of the one or more compute accelerators, may include one or more processing regions, of the plurality of processing regions, disposed at a large substrate (e.g., a rack-width substrate, printed circuit board (PCB), organic substrate, a substantially whole wafer, etc.). In some embodiments, mapping the plurality of model layers to the plurality of processing regions may include mapping successive model layers of the processing sequence to adjacent processing regions of the plurality of processing regions. For example, a first processing region of a first compute accelerator may be adjacent to a second processing region of a second compute accelerator. A first model layer may be mapped to the first processing region, and a second model layer following the first model layer in the processing sequence may be mapped to the second processing region. In this example, arranging the connections may include identifying, at the first processing region, one or more processing elements neighboring the second processing region and configuring one or more local communication paths between the one or more identified processing elements and the second processing region.

In some embodiments, the method includes retrieving, from local memory of the first processing region via the one or more local communication paths, model data for processing the one or more queries at the second processing region. In some embodiments, processing, using the ML model, the one or more queries may include determining, based on the one or more queries, a respective sequence of tokens, generating, at a respective processing region, model data associated with the respective sequence of tokens using a respective model layer, and storing, in local memory of the respective processing region, the model data. In some embodiments, the method may include mapping a de-embedding layer associated with the ML model to a last processing region of the plurality of processing regions for the processing pipeline and generating model output using the de-embedding layer. The ML model may be a target model, and the plurality of model layers may be a first plurality of model layers. In some embodiments, the method includes determining, based at least in part on the target model, a second plurality of model layers of a draft model, mapping the second plurality of model layers to the plurality of processing regions, determining one or more draft tokens by processing, using the draft model concurrently with using the target model, the one or more queries through the processing pipeline, and validating, using the target model, the one or more draft tokens.

In some embodiments, a method includes receiving one or more queries, determining a respective query stream corresponding to each query of the one or more queries, and identifying a plurality of processing regions of one or more compute accelerators. Each processing region of the plurality of processing regions may include a plurality of compute elements and memory elements positioned proximate to the plurality of compute elements within the processing region. The method may include storing, in respective memory elements of each processing region, model data and sequentially processing the respective query stream at the plurality of processing regions by retrieving, from the respective memory elements, the model data corresponding to the respective query stream.

In some embodiments, the one or more queries may include one or more sequences of tokens, wherein the respective query stream may include data associated with a respective sequence of tokens. In some embodiments, a portion of the memory elements of each processing region is to locally store a respective model data cache. In some embodiments, sequentially processing the respective query stream may include processing, at a first processing region, a first query stream by generating first model data associated with a first model layer, storing, at a model data cache of the first processing region, the first model data, and processing, at a second processing region, the first query stream. For example, processing, at the second processing region, the first query stream may include retrieving, from the model data cache, the first model data and generating, based at least in part on the first model data, second model data associated with a second model layer.

In some embodiments, the model data is stored at first memory elements of a first processing region, wherein the first processing region is adjacent to a second processing region, and wherein sequentially processing the respective query stream includes identifying, at the first processing region, one or more second memory elements neighboring the second processing region, retrieving, from the first memory elements via the one or more second memory elements, the model data, and processing, based at least in part on the retrieved model data, the respective query stream at the second processing region. In some embodiments, the first processing region is disposed at a first compute accelerator of the one or more compute accelerators, and the second processing region is disposed at a second compute accelerator of the one or more compute accelerators. For example, the first compute accelerator may include a first substrate, and the second compute accelerator may include a second substrate. In some embodiments, each processing region is associated with processing of a respective model layer of a model, wherein the model data may include KV data associated with the processing of the respective model layer. In some embodiments, the one or more compute accelerators may include one or more fabrics interconnecting compute elements of the plurality of processing regions. In some embodiments, a first compute accelerator, of the one or more compute accelerators, may include one or more processing regions, of the plurality of processing regions, disposed at a large substrate (e.g., a rack-width substrate, PCB, organic substrate, a substantially whole substrate or wafer, etc.).

In some embodiments, a compute accelerator includes a plurality of unsingulated dies (e.g., disposed at a single substrate) with communication connectivity between adjacent dies (e.g., disposed at the substrate). For example, interconnected dies associated with one or more processing regions across most or all of a substantially whole wafer may be configured as a neural processing unit for accelerating ML processes (e.g., artificial intelligence) including processing elements for compute and/or processing elements for memory. In some aspects, the one or more compute accelerators providing high memory bandwidth (e.g., comparable to static memory such as on-chip static random access memory (SRAM)) enables generating high-quality responses in autoregressive inference using the pipeline execution model without compromising the output quality.

As a non-limiting example, inference may be performed using a large language model (LLM), and the pipeline may be configured for processing data packets using the LLM. For example, LLMs can process text, image, speech, multimodal data, and other datasets and are not limited to language. LLMs are deep learning networks that may include many sequentially dependent layers including linear (e.g., matrix multiplication or convolution), nonlinear (e.g., ReLu, GeLu, tanh), and self-attention layers. The self-attention layers may depend on a key-value database of some previous number of tokens. The number of previous tokens in the key-value database may be referred to as the “context length.” In some embodiments, the key-value data is appended to a local cache at the processing region. For example, each self-attention layer can produce a new key and new value token to append to the key-value database.

It is noted and appreciated that any of the one or more embodiments described herein may include systems, methods, apparatuses, devices, computer-readable media, articles of manufacture, etc., without departing from the principles set forth in the present disclosure. One or more embodiments described in the present disclosure include one or more processes, one or more articles of manufacture, one or more apparatuses, one or more systems, one or more compositions of matter, and/or one or more non-transitory computer-readable mediums that provide improvements for executing autoregressive inference (e.g., memory bandwidth, computing performance, computing efficiency, power consumption, model accuracy, processing throughput, resource cost, etc.).

### BRIEF DESCRIPTION OF THE DRAWINGS

The following description includes description of figures having illustrations given by way of example of implementations of embodiments of the disclosure. The drawings should be understood by way of example, and not by way of limitation. As used herein, references to one or more “embodiments” are to be understood as describing a particular feature, structure, and/or characteristic included in at least one implementation. Thus, phrases such as “in some embodiments” appearing herein describe various embodiments and implementations, and do not necessarily all refer to the same one or more embodiment. However, they are also not necessarily mutually exclusive. It should be noted that for clarity and ease of illustration, these drawings are not necessarily made to scale. In the drawings:

FIG. 1 depicts an example system including configuring one or more compute accelerators to implement a sequence of model layers, in accordance with some embodiments of this disclosure;

FIG. 2 depicts an example diagram of a processing region including compute and local memory in the processing region, in accordance with some embodiments of this disclosure;

FIG. 3 depicts an example system including processing a plurality of queries (e.g., prompts) through a pipeline execution model, in accordance with some embodiments of this disclosure;

FIG. 4 depicts an example system including configuring a plurality of compute accelerators with respective processing regions to implement a sequence of model layers, in accordance with some embodiments of this disclosure;

FIGS. 5A-5C (collectively referred to as FIG. 5) depict example dataflow diagrams illustrating processing of one or more sequences of data packets (e.g., tokens), in accordance with some embodiments of this disclosure;

FIG. 6 depicts an example system including speculative decoding using a pipeline execution model, in accordance with some embodiments of this disclosure;

FIG. 7 depicts an example configuration of a compute accelerator including a plurality of processing elements disposed at a single substrate, in accordance with some embodiments of this disclosure;

FIG. 8 depicts a block diagram illustrating an example processing element and some components thereof;

FIG. 9 depicts an example layout including placement of processing regions at a compute accelerator and routing therebetween, in accordance with some embodiments of this disclosure;

FIG. 10 depicts an example diagram and layout including placement of processing regions at a compute accelerator, in accordance with some embodiments of this disclosure;

FIG. 11 is a flow diagram of an example process for inference using a pipeline execution model, in accordance with some embodiments of this disclosure; and

FIG. 12 is a flow diagram of an example process for processing data using a model including storing model parameters and/or model data in memory proximate to the compute, in accordance with some embodiments of this disclosure.

### DETAILED DESCRIPTION

It is contemplated that the processes, articles of manufacture, apparatuses, systems, compositions of matter, and/or non-transitory computer-readable mediums, and/or parts thereof described herein may incorporate one or more features of any one of the structures, apparatuses, assemblies, packages, etc., or may be formed by any one or a combination of the methods set forth in U.S. Nonprovisional patents application Ser. No. 17/771,410 (filed Apr. 22, 2022) and Ser. No. 17/771,606 (filed Apr. 25, 2022), each of which is hereby incorporated by reference herein in its respective entirety. The following paragraphs note some of the features and are intended to be illustrative and non-limiting. Any of the features may be included, modified, combined, etc. within the principles set forth in the present disclosure.

Any compute parameters described in the present disclosure may include any combination of scalars, vectors, matrices, tensors, and so forth, such as arrangements of an arbitrary number and an arbitrary complexity of elements. For example, the parameters are of various dimensions, such as one-dimensional, two-dimensional, three-dimensional, and otherwise multidimensional. For example, the parameters are of various datatypes, such as, integer and floating-point. For example, the parameters (or respective portions thereof, e.g., an exponent or a mantissa) are represented with various precisions (sometimes referred to as widths), such as, 8-bit, 16-bit, 32-bit, 64-bit, and so forth.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

An enumerated listing of items does not imply that any or all of the items are mutually exclusive, unless expressly specified otherwise.

The terms “a”, “an” and “the” mean “one or more”, unless expressly specified otherwise.

Devices, or components thereof, that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments. Further, although process steps, method steps, algorithms or the like may be described in a sequential order, such processes, methods, and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least particular operations that may have been illustrated in the figures show particular events occurring in a particular order. In some alternative embodiments, particular operations may be performed in a different order, modified, combined, or removed. Moreover, steps may be added to the above-described circuitry(ies) and conform to the described embodiments without departing from the principles set forth in the present disclosure. Some operations described herein may occur sequentially, and/or particular operations may be processed in parallel. Any operation may be performed by a single processor or by distributed processors.

As referred to herein, reference to a “substrate” are applicable to embodiments of a large substrate (e.g., a rack-width substrate, printed circuit board (PCB), organic substrate, a whole or substantially whole wafer, etc.) as well as to embodiments of a significant portion of a substrate (e.g., a significant portion of a wafer).

In some embodiments, a compute accelerator may include one or more specialized components, such as processing elements, device components, or other hardware elements. Some implementations include one or more processing circuit elements such as transistors, resistors, inductors, capacitors, wire interconnects, combinatorial logic (e.g., NAND, NOR) gates, latches, register files, memory arrays, tags for memory arrays, content-addressable memories, flash, ROM, DRAM, SRAM, Serializer/Deserializer (SerDes), I/O drivers, and the like, such as implemented via custom logic, synthesized logic, ASICs, and/or FPGAs. Some example processing elements include one or more application specific integrated circuits (ASICs), such as central processing units (CPUs), graphics processing units (GPUs), tensor processing units (TPUs), neural processing units (NPUs), etc., including combinations and/or variants thereof. One or more compute accelerators may include processing elements coupled via a unifying compute fabric (“fabric” henceforth) and enabled to communicate with each other via the fabric. The processing elements and the fabric may be collectively referred to as a fabric of processing elements on a single compute accelerator or a plurality of compute accelerators coupled to each other.

In some embodiments, a processing element includes a router to communicate data packets (e.g., network packets, fabric packets, etc.) via the fabric and a CE to process the data packets. In some embodiments, a router may be coupled to a plurality of elements: a fabric, an off ramp to the compute element, and an on ramp from the compute element. In some embodiments, a coupling between the router and the fabric enables communication between the router and, e.g., four logically and/or physically adjacent processing elements. The router variously receives data packets from the fabric and the on ramp. The router variously transmits data packets to the fabric and the off ramp.

In some embodiments, a CE includes hardware elements that collectively execute the instructions based on receiving an associated data packet by performing operations specified by the instructions (e.g., arithmetic operations, control flow operations, and load/store operations). In some embodiments, the instructions are provided to the compute element separately from the associated data packet. Examples of the hardware elements include picker queues, a picker, a task definition table, an instruction sequencer, an instruction decoder, a data sequencer, a register file, a memory, a pseudo-random number generator, and an ALU. Some implementations of the hardware elements are in accordance with hardware logic circuitry elements as described elsewhere herein. A compute element may be referred to as a compute engine. A compute scheduler may be referred to as a picker, and a compute scheduler queue may be referred to as a picker queue. A CE may be enabled to process data packets by initiating tasks and executing instructions associated with the data packets, and accessing data associated with the data packets and/or the instructions. The instructions are in accordance with an instruction set architecture comprising arithmetic instructions, control flow instructions, datatype conversion instructions, configuration instructions, fabric management instructions, and load/store instructions. The instructions operate on operands comprising various datatypes, e.g., integer datatypes and floating-point datatypes of various widths. The operands variously comprise scalar operands and vector operands. In various embodiments and/or usage scenarios, a vector variously represents, e.g., weights of a neural network, inputs or stimuli of a neural network, activations of a neural network, and/or partial sums of a neural network. In some scenarios, a vector is a sparse vector (e.g., a vector of neuron activations) and comprises sparse data elements (e.g., only non-zero elements). In some other scenarios, a vector is a dense vector (e.g., pixel values) and comprises dense data elements (e.g., all elements of the vector, including zero elements).

In some embodiments, a fabric includes a collection of logical and/or physical couplings between processing elements and/or within a single processing element. The fabric may be configured to implement logical and/or physical communication topologies such as a mesh, a 2D mesh, a 3D mesh, a hypercube, a torus, a ring, a tree, or any combination thereof. An example of a physical coupling between processing elements is a set of physical interconnects (comprising optional and/or selective buffering) between physically-coupled processing elements. A first example of physically-coupled processing elements is immediately physically adjacent processing elements, such as a first processing element located directly beside (such as ‘north’, ‘south’, ‘east’, or ‘west’) of a second processing element. A second example of physically-coupled processing elements is relatively physically nearby processing elements, such as a first processing element located within a relatively small number of intervening processing elements, e.g., one or two ‘rows’ and/or ‘columns’ away from a second processing element. A third example of physically-coupled processing elements is relatively physically far away processing elements, such as a first processing element located physical relatively far away from a second processing element, such as a distance limited by signal propagation (with or without optional and/or selective buffering) within a clock cycle and/or clock sub-cycle associated with the processing elements. An example of physical coupling within a single processing element (having, e.g., a compute element and a router) is an on ramp coupling output information from the compute element to the router, and an off ramp coupling input information from the router to the compute element. In some embodiments, the router routes information from the on ramp to the off ramp. The router may route from the on ramp and through a number of zero or more hops to one or more consecutively adjacent routers and/or zero or more off-ramps (e.g., a plurality of off-ramps).

In some embodiments, memory or storage includes one or more elements enabled to retain state information, e.g., any one or more of: a flip-flop, a latch or an array of latches, a register or an array of registers, a register file, a memory, a memory array, a magnetic storage device, an optical storage device, SRAM, DRAM, flash, and ROM. In various embodiments storage is volatile (e.g., SRAM or DRAM) and/or non-volatile (e.g., flash or ROM).

In some embodiments, a compute accelerator may include wafer-scale integration by implementing a system using all or a significant portion of a large substrate as an element of the system, e.g., by leaving a large substrate whole or substantially whole. In some embodiments, wafer-scale integration enables connecting multiple elements in a system via substrate interconnects formed using semiconductor fabrication processes instead of via inter-chip interconnect, and may improves any one or more of improved performance, cost, reliability, and energy efficiency. As an illustrative example, a system implemented using wafer-scale integration technology enables implementation of more than one billion PEs on a single substrate, each of the PEs having bandwidth to nearest physical neighbors that is greater than a comparable system using other-than wafer-scale integration technology. The greater bandwidth enables the system implemented using wafer-scale integration technology to relatively efficiently train and/or perform inferences for larger neural networks than the system implemented using other-than wafer-scale integration technology.

In some embodiments, a logical coupling between processing elements includes a virtual channel as implemented by routers within processing elements. A route between a first processing element and a second processing element is implemented, e.g., by routers within processing elements along the route forwarding in accordance with the virtual channel and routing configuration information. An example of a logical coupling within a single particular processing element (having, e.g., a router) is a virtual channel as implemented by the router, enabling the particular processing element to send information via the virtual channel to the particular processing element. The router forwards with respect to the particular processing element in accordance with the virtual channel and routing configuration information.

In some embodiments, a data packet (e.g., fabric packets, network packets, etc.) includes a bundle of information communicated between processing elements via the fabric. In some embodiments, a data packet may include one or more fields indicative of a payload and/or a virtual channel (e.g., a virtual channel identifier). A payload may include data and may be associated with instructions. For example, a first response to a data packet received by a compute element of a processing element may include the compute element initiating a task, such as corresponding to processing of instructions associated with the data packet. For example, a second response to a data packet received by a compute element of a processing element may include the compute element processing data of the data packet. Some example types of data packets include dense packets and sparse packets, as well as data-type and control-type.

Data packets may be used, for example, for communicating between processing elements. For example, a first processing element may transmit data packets to a second processing element. For example, an external device (e.g., an FPGA) may transmits data packets to a processing element. For example, a processing element transmits data packets to an external device (e.g., an FPGA).

In some embodiments, a virtual channel includes one or more communication pathways specified by a virtual channel identifier (e.g., a color field) and may be enabled, e.g., by a fabric and one or more routers. A data packet including a particular virtual channel identifier is sometimes referred to as being associated with a particular virtual channel (e.g., associated with a particular color). A first example of a color is a fabric color specifying a virtual channel between two different processing elements. In some embodiments, a fabric color is a 5-bit integer. A second example of a color is a local color specifying a virtual channel from a processing element to the processing element. In some embodiments, a color is a 6-bit integer and specifies one of a fabric color and a local color.

An example task may include a collection of instructions executed in response to a data packet. An example instruction may include an operation and optionally one or more operands specifying locations of data elements to be processed in accordance with the operation. A first example of an operand specifies data elements in memory. A second example of an operand specifies data elements communicated (e.g., received or transmitted) via the fabric. An example of a data sequencer determines the locations of data elements. An example of an instruction sequencer determines an address in memory of instructions associated with a data packet. An example picker queue is enabled to hold data packets received via an off ramp of the fabric for processing in the compute element. An example of a picker selects a data packet from the picker queue for processing, and/or selects an active unblocked virtual channel identifier for processing to initiate a corresponding task.

An example of storage is one or more elements enabled to retain state information, e.g., any one or more of: a flip-flop, a latch or an array of latches, a register or an array of registers, a register file, a memory, a memory array, a magnetic storage device, an optical storage device, SRAM, DRAM, flash, and ROM. In various embodiments storage is volatile (e.g., SRAM or DRAM) and/or non-volatile (e.g., flash or ROM).

An example of an Integrated Circuit (IC) is a collection of circuitry implemented on one or more portions of semiconductor material, such as a single die or a plurality of dies. An example of 3D-stacking of dies is providing mechanical connectivity and/or electrical connectivity between the dies, e.g., in a dimension orthogonal to a major surface of the dies, to form a unit. The mechanical connectivity and/or the electrical connectivity are variously implemented, e.g., via one or more of solder balls, microbumps, hybrid bonds, and through-substrate vias. An example of 2.5D stacking of dies is providing mechanical connectivity and/or electrical connectivity between the dies via a common element (e.g., an interposer) to form a unit, wherein the mechanical connectivity and/or electrical connectivity between each die and the substrate is in a dimension orthogonal to a major surface of the die. The mechanical connectivity and/or the electrical connectivity are variously implemented, e.g., via one or more of solder balls, microbumps, and through-substrate vias. An example of an Application-Specific Integrated Circuit (ASIC) is an IC designed for a particular use.

An example of a package is an element enabled to mechanically retain and/or contain one or more electronic circuits and/or to electrically interconnect one or more electronic circuits. Example electronic circuits are any one or more of one or more portions of semiconductor material, one or more dice, one or more interposers, and one or more substrates. Particular examples of packages include a BGA package and variants thereof. Some ICs comprise a package. An example of a substrate is an element to mechanically retain and/or electrically interconnect one or more dice and/or one or more packages. An example of a substrate includes a PCB, to, e.g., retain and interconnect packages. An example of a substrate includes an interposer to, e.g., couple one or more 3D-stacked or 2.5-stacked dice. An example of a substrate includes a package, e.g., retaining a plurality of dice.

An example of inter-package communication is communication between packages, e.g., between a first package and a second package. A particular example of inter-package communication is communication between a first BGA mounted on a PCB and a second BGA mounted on the PCB. An example of intra-package communication is communication within elements of a package. A particular example of intra-package communication is communication between a first die in a package and a second die in the package. An example of intra-substrate communication is communication between elements of a substrate, such as between a first package mounted on a PCB and a second package mounted on the PCB. An example of inter-die communication is communication between dice, such as between a first 3D-stacked die of a package and a second 3D-stacked die of the package. Some inter-die communication is in accordance with intra-package communication. Some inter-die communication is in accordance with intra-substrate communication. An example of intra-die communication is communication between elements of a same die, such as between electrically interconnected routers of a same die.

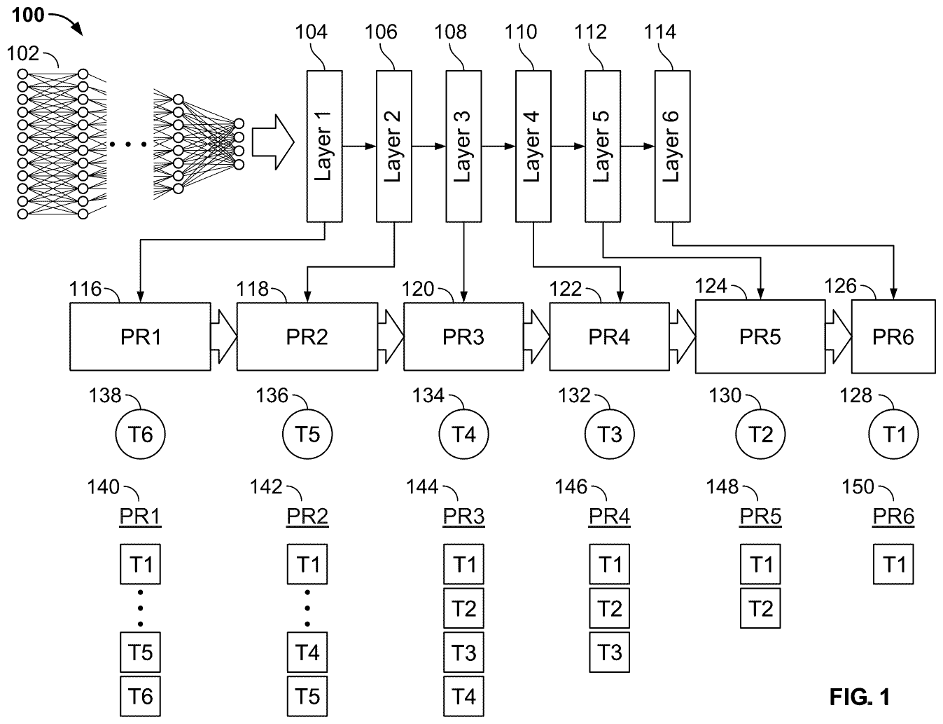

FIG. 1 depicts an example system 100 including configuring one or more compute accelerators to implement a sequence of model layers 104-114 of a model 102, in accordance with some embodiments of this disclosure. At FIG. 1, the system 100 includes circuitry (e.g., processing circuitry, control circuitry, compute host, process driver, etc.) to configure one or more compute accelerators to implement a processing sequence of the ML model 102, wherein the ML model includes a plurality of model layers 104-114. The circuitry maps, based at least in part on the processing sequence, the plurality of model layers 104-114 to a plurality of processing regions (PR) 116-126 of the one or more compute accelerators and arranging connections between the plurality of PRs to form a processing pipeline corresponding to the processing sequence. Model parameters and/or other associated data for executing the model layers 104-114 may be stored in memory at the respective processing regions. The circuitry may receive one or more queries. Based at least in part on receiving the one or more queries, the circuitry processes, using the ML model, the one or more queries through the processing pipeline. Although six model layers are shown at FIG. 1, it is noted that any number of model layers of any size may be mapped to any number of processing regions and/or any number of compute accelerators. It is noted that the processing regions may have any size and shape based on the number of PEs allocated in the region.

At FIG. 1, a query may include a sequence of tokens 128-138 that are to be processed through the PRs 116-126. Each of PRs 116-126 include respective memory (e.g., memories 140-150) for storing model data (e.g., KV data) from processing the corresponding token(s). For example, the token 128 is to be processed at PR 126, and associated model data is stored at memory 150 of the PR 126. For example, the tokens 128-138 may have been processed through PR 116, and associated model data are stored at memory 140 for PR 116. Any of the PRs 116-126 may retrieve data from memory of another PR. For example, PR 126 may retrieve model data associated with processed tokens from any of memories 140-150. For example, PR 126 may retrieve model data for token 134 from memory 144.

In some embodiments, processing one or more streams of data packets using the pipeline execution model includes optimizing size and/or concurrency of model layers, which desirably reduces (e.g., minimizes) latency. For example, any of the model layers 104-114 may be adjusted, e.g., by modifying one or more model parameters of a model layer such as a number of nodes, connections between nodes of model layers, etc. For example, processing times of the plurality of processing regions be adjusted (e.g., using one or more delay buffers) such that the model layers 104-114 are concurrently processed. As used herein, the term “model parameter” or “parameter” refers to any ML model parameter including variables (e.g., model weights), number of layers, interlayer connections, number of nodes in a respective layer, etc., that may be adjusted such as before execution and/or during execution of the model.

In some embodiments, the pipeline execution model may be organized as regions of processing elements, each region capable of running the assigned ML model layer(s) and interleaving the process streams among the regions. In some embodiments, model parameters and/or data is to be stored at a central portion of a processing region. The pipeline execution model may include assigning sequential multiple layers to processing elements located within the same physical region for running sequentially in time (e.g., on the same physical resources). For example, the matrix parameters may be stored directly on the respective processing cores so that there is no minimum use count for a parameter. In some aspects, tokens do not have to be batched as they enter stages of the pipeline (e.g., each matrix-vector step uses matrix parameters only once). The matrix multiplications may be arranged so that inputs may be accepted and processed by processing elements at any part of the region (e.g., accepted at a center column, processed/outputted at a central row, etc.) and are not limited to being accepted or being outputted by processing elements at the edges of the region. The next matrix corresponding to the next token may be arranged in a transposed orientation. The associated data may be transported using a perpendicular route from a result row to an input column. Using processing elements at any part of the region (e.g., the center) reduces the communication length (e.g., by half in some instances) and thereby reduces computation latency. After the operations of a number of layers have been completed, the pipeline may pass the outputted data through a communication route to the next physically adjacent region for the next set of layers.

In some embodiments, executing a pipeline execution model includes executing a decoding algorithm. The decoding algorithm may be model-agnostic. For example, the decoding algorithm may be implemented for inference using any ML model or a particular class of ML models (e.g., a transformer-based model). The decoding algorithm may include one or more decoder elements, such as fully connected layers, attention mechanisms, normalization functions, filtering, and/or activation functions (e.g., non-linear sigmoid functions). A transformer-based model may include various model components, such as tokenizers, embedding layers, transformers (e.g., encoding layers, decoder layers, etc.), and unembedding layers. For example, each processing region may be arranged as a decoder including PEs configured as one or more decoder elements for the model (e.g., fully connected layers, attention, normalization, filtering, non-linear activation such as a sigmoid function, etc.) In some embodiments, one or more processing regions include a plurality of decoders for each region. Positioning of the regions and decoders per respective region may be spatially mapped to regions of one or more compute accelerators, where the positions of the regions relative to each other follow the sequential processing of model layers.

In some embodiments, one or more processing regions may be mapped to a plurality of models (e.g., expert neural networks). Each model may have been trained for specialized performance on a particular task or subset of data. For example, a plurality of models may be mapped to the same processing region by selecting and storing model parameters at the processing region corresponding to the task in which each model specializes. In some embodiments, data between PEs in the processing region is locally routed, e.g., by using respective model parameters for each model and preventing load balancing between the models.

In some aspects, the local routing enables low latency execution without cross-device communication contributing to the latency.

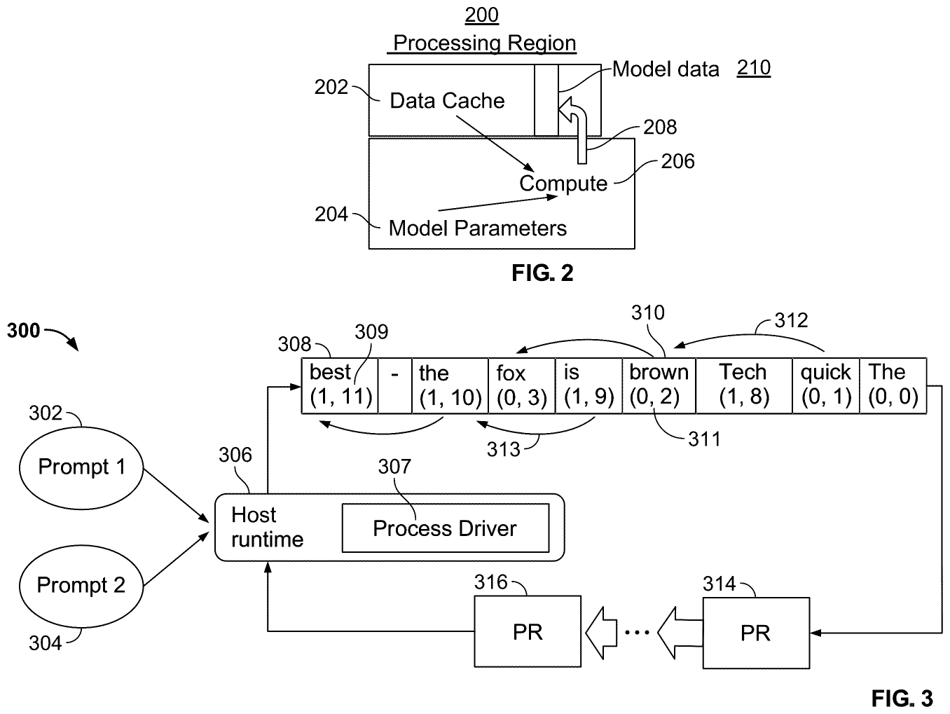

FIG. 2 depicts an example diagram of a processing region 200 including compute 206 and local memory in the processing region, in accordance with some embodiments of this disclosure. At FIG. 2, the PR 200 is organized in sections and configured for a particular task such as compute PEs at the compute 206 and/or memory PEs at the data cache 202. In some aspects, the PR 200 is organized for a near-compute memory architecture. The PR 200 may include a plurality of PEs distributed across most of all of the region. In some embodiments, the PEs include unsingulated dies disposed at a substrate. In some embodiments, each PE includes at least one compute element and/or memory (e.g., SRAM or another memory type). The PR 200 includes a first portion of memory for storing model parameters 204 (e.g., model weights) and/or other associated data for executing a model layer. The model parameters 204 may be stored, e.g., in memory of the compute PEs for the compute 206. The PR 200 includes a portion of memory for a data cache 202 for storing model data 210. For example, the data cache 202 may include a KV database. Compute PEs at the compute 206 may retrieve model parameters 204 and/or model data from the data cache 202 to process one or more data packets (e.g., one or more tokens). After processing, the model data 210 is stored (e.g., via one or more communication paths 208) at the data cache 202. For example, keys and values from processing one or more tokens using the compute 206 may be appended to a KV database at the data cache 202.

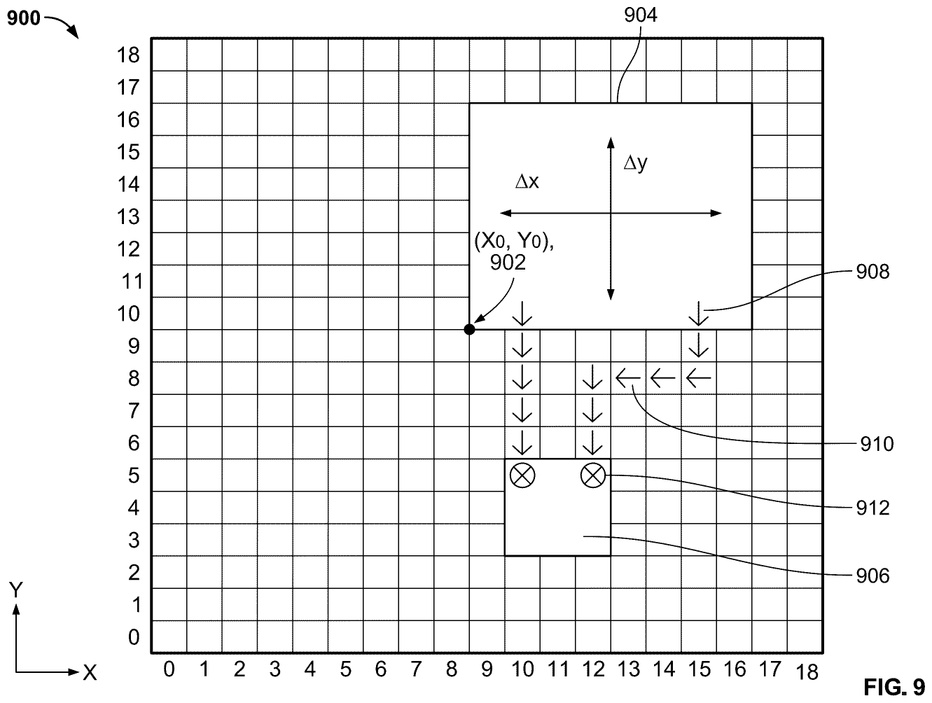

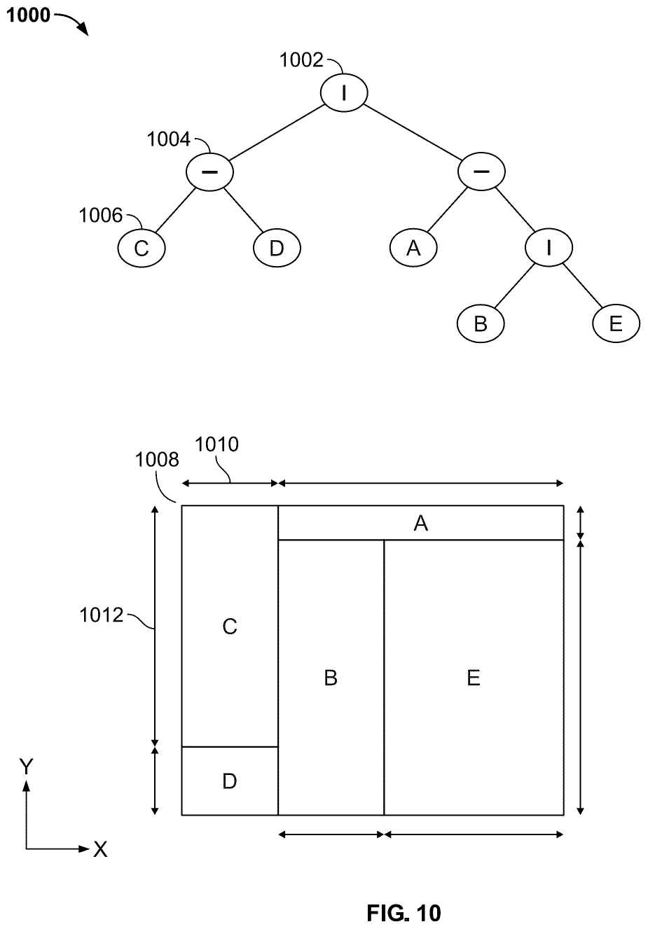

In some embodiments, the data cache 202 may correspond to any of the memories 140-150. The organization of the PEs in a processing region is described in detail with respect to FIGS. 9-10. It is noted that the sections are intended to be illustrative and non-limiting. For example, data cache 202 and compute 206 may include interleaved sections of PEs. For example, PEs at a periphery of the PR 200 (e.g., along each edge of the PR 200) may be configured as the data cache 202. Although not shown at FIG. 2, in some embodiments, one or more PEs in the PR 200 may be configured for delivering data (e.g., sending to and/or receiving from another processing region, between PEs within the PR 200, etc.).

FIG. 3 depicts an example system 300 including processing a plurality of queries (e.g., prompts 302-304) through a pipeline execution model, in accordance with some embodiments of this disclosure. The pipeline may include any number of processing regions such as PRs 314-316. The prompts 302-304 are processed at the PRs 314-316, and model data is stored in memory of a respective processing region, e.g., as described with respect to data cache 202 at FIG. 2. As referred to herein, prompts are external inputs to an ML model such as from a user input, search engine, application interface, a written document, image(s), video(s), etc. Continuing with FIG. 3, the system 300 receives a first prompt 302 and a second prompt 304. A compute host 306 (e.g., a host runtime, etc.) may manage the processing of the prompts 302-304. The host 306 may include a process driver 307 (e.g., a software driver, a device driver, etc.). As an illustrative example, the first prompt 302 may include a first sequence (e.g., token 308), and the second prompt 304 may include a second sequence (e.g., token 310). Streams for the prompts 302-304 are iterated through the pipeline, and output may be generated after a particular number of iterations. For example, a first stream 312 may be processed for the first sequence, and a second stream 313 may be processed for the second sequence. Tokens of the first stream are interleaved with tokens of the second stream for the PRs 314-316. The compute host 306 may inject the prompts 302-304 at each iteration. In some embodiments, each token is associated with metadata. For example, the token 308 may be associated with metadata 309, and the token 310 may be associated with metadata 311. For example, the metadata may indicate a sequence identifier, a position identifier within the respective sequence, and/or an associated storage location (e.g., an address for the data cache 202). For example, the token 310 may be associated with a first sequence or stream (e.g., sequence ID number 0 having a position ID number 2 as indicated by the metadata 311), and the token 308 may be associated with a second sequence or stream (e.g., sequence ID number 1 having a position ID number 11 as indicated by the metadata 309).

As an illustrative example, processing circuitry of the system 300 may receive one or more queries including the first prompt 302 and the second prompt 304, determine a respective query stream corresponding to each query of the one or more queries (e.g., the first stream 312 and the second stream 313 corresponding to the prompts 302, 304, respectively), and identify a plurality of processing regions (e.g., PRs 314-316) of one or more compute accelerators. Each processing region of the plurality of processing regions may include a plurality of compute elements and memory elements positioned proximate to the plurality of compute elements within the processing region. The processing circuitry may store, in respective memory elements (e.g., the data cache 202) of each processing region, model data (e.g., the model data 210) and sequentially process the respective query stream at the plurality of processing regions by retrieving, from the respective memory elements, the model data (e.g., the model data 210) corresponding to the respective query stream.

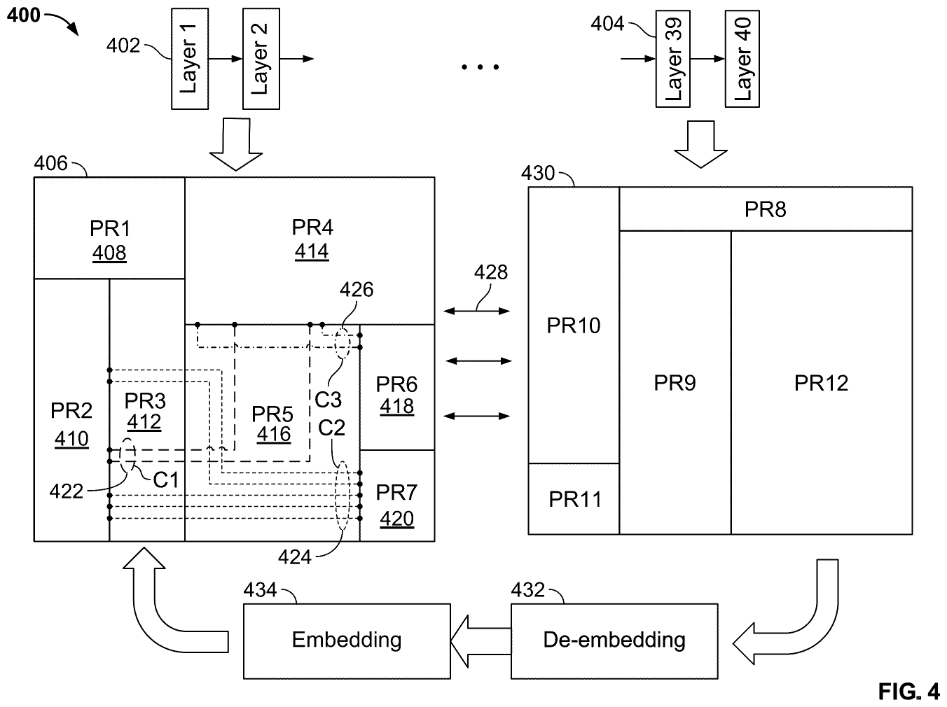

FIG. 4 depicts an example system 400 including configuring a plurality of compute accelerators 406, 430 with respective processing regions to implement a sequence of model layers 402-404, in accordance with some embodiments of this disclosure. In some embodiments, a ML model is mapped across a plurality of compute accelerators. For example, storing the model parameters and corresponding key-value databases of the ML model's layers may be allocated more memory than available on a single compute accelerator (e.g., a hardware node). For example, model layers of a model may be assigned to PRs of different compute accelerators based on an amount of compute and/or memory for executing a model layer.

The system 400 includes a first compute accelerator 406 and a second compute accelerator 430. The first compute accelerator 406 includes a first plurality of PRs (e.g., PRs 408-420). At FIG. 4, a first plurality of model layers (e.g., model layers 402) is mapped to the first plurality of PRs. The second compute accelerator 430 includes a second plurality of PRs, wherein a second plurality of model layer (e.g., model layers 404) is mapped to the second plurality of PRs. The PRs of the compute accelerators 406, 430 are arranged based on the sequence of the model layers 402-404. Communication paths may be formed between PRs within a compute accelerator (e.g., routing paths 422-426 at the first compute accelerator 406) and/or between different compute accelerators (e.g., interface 428 between the first compute accelerator 406 and the second compute accelerator 430).

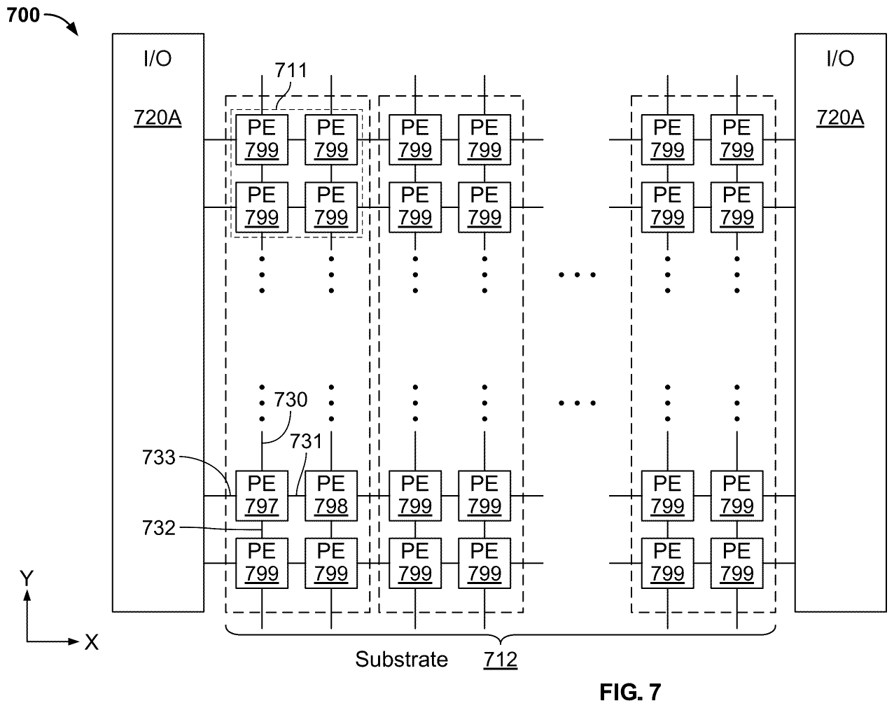

In some embodiments, the processing elements may be coupled via a fabric, wherein fabric elements of the fabric may connect processing elements of a plurality of processing regions. For example, each processing element may include a fabric router coupled to the fabric. Communication paths between PRs may be formed using the fabric elements from one or more first PEs to one or more second PEs. For example, one or more paths may be formed between a first PE of a first PR and a second PE of a second PR by connecting respective fabric routers of the first and second PEs and/or any PEs disposed therebetween. For example, one or more PEs may be disposed between the first PE and the second PE, and routing paths (e.g., any of routing paths 422-426) may be formed using the fabric elements between adjacent PEs, starting from the first PE to a neighboring PE and onwards to the second PE, e.g., as described with respect to FIGS. 7-9.

In some embodiments, each processing element of the respective plurality of processing elements includes a router, wherein respective routers of adjacent processing elements are connected via one or more wiring elements between the respective routers. Communication paths between PRs may be formed using the one or more wiring elements between the respective routers. For example, one or more paths may be formed between a first PE of a first PR and a second PE of a second PR by connecting respective router ports of adjacent PEs. For example, the first PE may be adjacent to the second PE, and routing paths (e.g., any of routing paths 422-426) may be formed using the wiring elements therebetween. For example, one or more PEs may be disposed between the first PE and the second PE, and the routing paths may be formed using the wiring elements between adjacent PEs, starting from the first PE to a neighboring PE and onwards to the second PE, e.g., as described with respect to FIGS. 7-9.

At the system 400, the communication paths may be arranged to deliver data packets following the sequence of model layers 402-404. For example, a sequence of data packets may be processed from PR 408 to PR 410 to PR 412, etc., at the first compute accelerator 406. The sequence of data packets may be passed to the second compute accelerator 430 via the interface 428 to the next processing region. After processing the data packets, output (e.g., output tokens, generated text, etc.) associated with the sequence of data packets may be generated, e.g., via the PRs and a de-embedding 432. The output may be iterated through the PRs until meeting one or more criteria, such as a pre-defined accuracy, via an embedding 434 and subsequent processing at the compute accelerators 406, 430. In some embodiments, a third compute accelerator, or one or more processing regions thereof, is configured for the de-embedding 432. In some embodiments, a fourth compute accelerator, or one or more processing regions thereof, is configured for the embedding 434. In some embodiments, the embedding 434 may correspond to the compute host 306 as described with respect to FIG. 3.

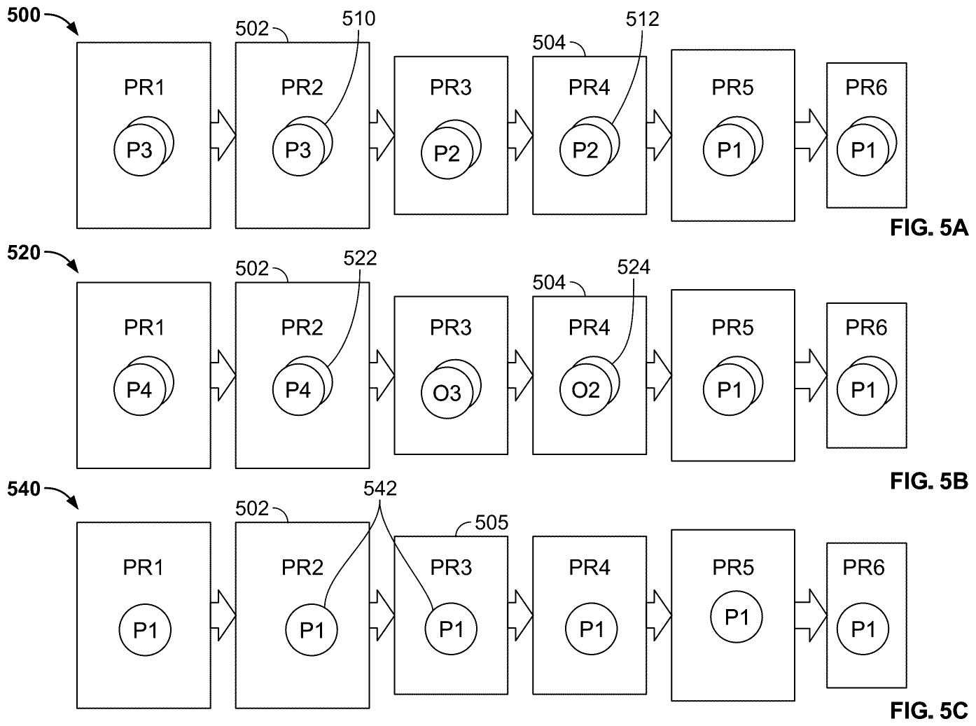

FIG. 5 depicts example dataflow diagrams 500, 520, 540 illustrating processing of one or more sequences of data packets, in accordance with some embodiments of this disclosure. In some aspects, the pipeline execution model may include utilizing any number of idle regions for concurrent processing of data packets. At FIGS. 5A-5C, a pipeline execution model includes a plurality of processing regions such as PR 502, 504, 505. The same pipeline execution model is shown for the diagrams 500, 520, 540 for illustrative purposes and is intended to be non-limiting. Different pipelines may be included without departing from the principles set forth in the present disclosure. It is noted that the following configurations are intended to be non-limiting and non-exhaustive and may include combinations and/or variants thereof without departing from the principles set forth in the present disclosure.

At FIG. 5A, in some embodiments, a pipeline execution model may be configured for processing a plurality of queries (e.g., a plurality of prompts from user inputs). Each prompt may be associated with a respective sequence of prompt tokens (or other associated tokens such as output tokens). Each processing region may be used to process at least one prompt token of each prompt. For example, if there are six processing regions available in the pipeline, then each region may concurrently process at least one prompt token (or other type of token) from six prompts in their respective sequence.

In some embodiments, the pipeline execution model may be configured for interleaving sequences of prompt tokens and/or other types of tokens. For example, if there are six regions available and two or more sequences of prompt tokens, the pipeline may process the prompts of the two or more sequences by alternating which sequence is processed between regions. For example, the diagram 500 shows three prompt streams to be processed. A first prompt stream may include one or more prompt tokens 512 at the PR 504, and a second prompt stream may include one or more prompt tokens 510 at the PR 502. At the diagram 500, three prompt streams are to be concurrently processed. For example, prompt tokens of the first prompt stream may be concurrently processed at a pair of adjacent PRs in the pipeline, and prompt tokens of the second prompt stream may be concurrently processed at a different pair of adjacent PRs in the pipeline.

In some embodiments, the pipeline may be configured for interleaving sequences of different types of tokens. FIG. 5B shows four streams of tokens interleaved in the pipeline. At the diagram 520, the pipeline is to process a first prompt stream, a second output stream, a third output stream, and a fourth prompt stream. For example, an output token 524 of the second output stream is to be processed at the PR 504, and a prompt token 522 of the fourth prompt stream is to be processed at the PR 502. For example, a first stream corresponding to a sequence of prompt tokens may be interleaved with a second stream corresponding to a sequence of output tokens. For example, if there are six regions available, the pipeline may process prompt tokens of a first sequence and output tokens of a second sequence by alternating which token type is processed between regions.

In some embodiments, processing of a single stream may be prioritized, and every processing region of the pipeline is utilized for processing the prioritized stream. At FIG. 5C for example, each PR processes each token of the sequence of prompt tokens in the prioritized prompt stream such as the prompt tokens 542 at the PRs 502, 505. For example, the PRs may be configured for maximum processing performance such as by increasing (e.g., maximizing) the number of compute PEs.

In some embodiments, processing one or more streams of data packets using the pipeline execution model includes flexible interleaving of variable sequence length, streams of different types of tokens (e.g., prompt type, generation type, etc.), and/or a plurality of query streams. In some aspects, increased throughput may be available by mixing two or more token streams in the pipeline and/or by using prompt tokens. In some embodiments, prompt tokens may enter stages of the pipeline in consecutive timesteps including before the prior token has exited the pipeline. For example, each token may be processed, e.g., using a self-attention layer before the next token in the sequence is processed using the corresponding self-attention layer.

Interleaving the sequences of tokens may be scheduled. In some embodiments, processing of the sequences of tokens may be dynamically scheduled, e.g., by the compute host 306 at FIG. 3. In some embodiments, memory may be overallocated between processing regions. For example, memory cache (e.g., the data cache 202) for processing a token may overlap between processing regions when a neighboring region has available memory. In some beneficial aspects, concurrent processing of two or more regions involves separately allocated on-chip resources and desirably does not impact compute performance, accuracy, and/or throughput of the processing in each region.

In some embodiments, the pipeline may be configured for batch token processing per region. That is, a region may be configured for processing one or more tokens at a time. The number of batches may be dynamically configured. For example, a plurality of tokens of a first stream may be concurrently processed in a first processing region (e.g., a local batch size parameter is set to be greater than one), and a plurality of tokens of a second stream may be concurrently processed in a second processing region. For example, a stream may be processed by first and second regions, where each of the first and second regions process a plurality of tokens from the same stream.

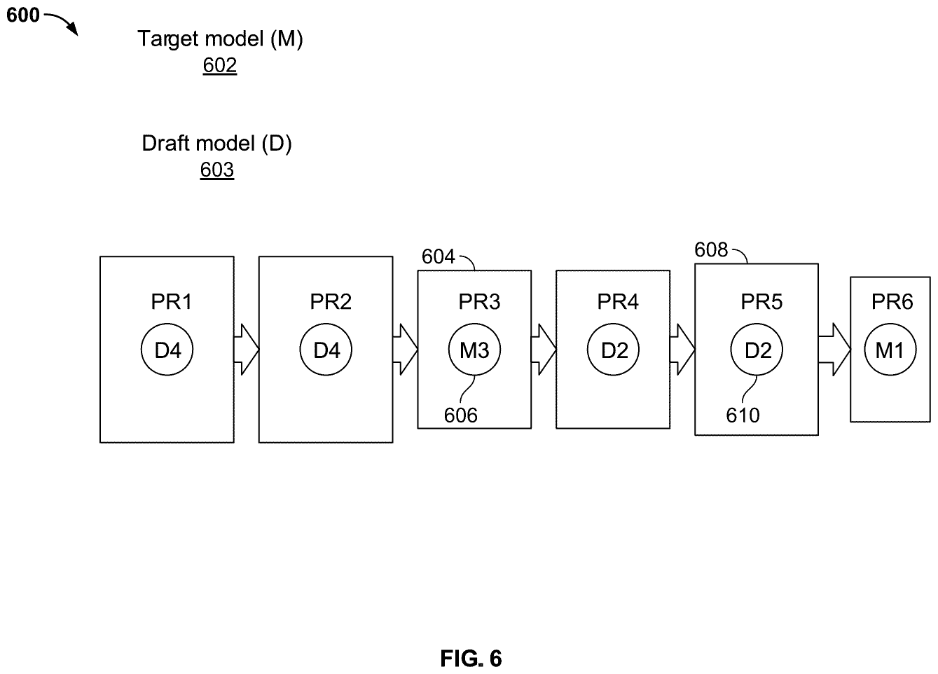

FIG. 6 depicts an example system 600 including speculative decoding using a pipeline execution model, in accordance with some embodiments of this disclosure. In some embodiments, one or more pipeline stages and associated regions run speculative decoding. At FIG. 6, a target model 602 and a draft model 603 may be mapped to a plurality of processing regions (e.g., PRs 604, 608). For example, one or more of the next tokens are predicted (e.g., as speculative tokens) concurrently using the draft model 603 based on values of previous tokens and validated or discarded using the target model 602. For example, a draft model may generate one or more speculated tokens (referred to as draft tokens) at one or more pipeline stages and associated regions, and a target model may verify the speculated tokens (referred to as target tokens) as the tokens are generated by the draft model. The draft model may correspond to a first process stream, and the target model may correspond to a second process stream. In some embodiments, model parameters and/or associated data for one or both of the models 602, 603 is stored at each processing region. Respective sequences of tokens (e.g., target token stream(s), draft token stream(s)) are processed through the pipeline execution model. For example, a target token 606 of a third target model stream is to be processed at the PR 604, and a draft token 610 of a second draft model stream is to be processed at the PR 608.

As an illustrative example, a first token (e.g., a word) may be computed, and the next token or more subsequent tokens (e.g., the next word(s) in a sentence structure) following the first token can be predicted using the output data stemming from computing the first token. If the next one or more tokens are verified by the model, then the corresponding processing of the predicted tokens may be skipped. That is, for an nth token, a token corresponding to (n+1) is generated, then another token corresponding to (n+2), etc. may be predicted and verified, where the latest verified token (e.g., (n+4)-th token) in the sequence of predictions is inputted to the pipeline and the preceding tokens (e.g., tokens n+3, n+2, n+1) would not need to be processed by the pipeline, which can improve compute performance and increase throughput by saving processing time, reducing number of memory access operations, and improve computing efficiency. Here, the model may be extended with tokens that predict output for k tokens in the future. When a sequence of tokens reaches the end of the pipeline, for example, the output may include token n+1 (generated) and tokens n+2, . . . , n+k (speculated). All of these tokens (e.g., n+1, . . . , n+k) may be inputted to the pipeline next. In the resulting output from the pipeline, at least n+2 token is generated accurately, but there could be a matching sequence for any successive tokens that were inputted including to n+k. The cycle repeats starting with inputting the last correctly speculated token of the matching sequence to the pipeline and skipping the preceding tokens, which saves processing time in proportion to the correct speculation rate. In some beneficial aspects, executing speculative decoding by processing the associated tokens may be performed in parallel with processing the sequence of other tokens in the pipeline. In some beneficial aspects, the pipeline architecture enables interleaving these process streams at token-level granularity. That is, the pipeline model described herein enables interleaving different types and/or streams of tokens. For example, prompt tokens can enter the stream back-to-back, but generated tokens need some spacing between them to account for latency of the entire sequential dependence chain. Different streams can be interleaved without interfering with the compute or memory performance of other pipeline stages.

In some embodiments, processing one or more streams of data packets using the pipeline execution model includes beam search and speculative execution. For example, utilization and generation accuracy can be increased by performing a beam search (e.g., and/or the auto-regressive evaluation) at any stage of a pipeline execution model. For example, in a beam search, several high probability tokens may be chosen at each stage of the pipeline execution model, and the high likelihood sequences are chosen. A sequential form may be a greedy (stochastic) search that commits to each token as soon as its probability vector is generated.

FIG. 7 depicts an example configuration of a compute accelerator 700 including a plurality of processing elements 799 disposed at a single substrate 712, in accordance with some embodiments of this disclosure. Each of PE 799 elements has couplings to other of PE 799 elements. For example, two of the PE elements (PE 797 and PE 798) are illustrated with unique identifiers and are otherwise respectively identical to instances of PE 799. PE 797 is illustrated with identifiers for each of four couplings (North coupling 730, East coupling 731 with PE 798, and South coupling 732) to others of the PEs and one of the interface elements, such as I/O 720A (e.g., via West coupling 733), but is otherwise identical to others of the PE elements. In some embodiments, the couplings are logical and/or physical. In some embodiments, the couplings are to communicate data packets, backpressure information, or both. In some embodiments, all or any portions of the physical couplings are to physically adjacent PEs. In some embodiments and/or usage scenarios, the PEs are physically implemented in a 2D grid layout. For example, the PEs may be physically implemented in a 2D grid layout of aligned rectangles, and physically adjacent PEs correspond to PEs sharing a horizontal boundary (North/South PEs with respect to each other) and PEs sharing a vertical boundary (East/West PEs with respect to each other). In some embodiments, any of the PEs 799 include one or more of a different amount of memory, differing coupling technology, different power consumption, different operating frequency, etc.

In some embodiments, any one or more of the couplings between PEs may include a plurality of high-speed serial couplings, e.g., SerDes couplings, sometimes referred to as SERDES techniques.

In some embodiments, an array of ASICs is formed on a substrate (e.g., the substrate 712), and each of the ASICs comprises a plurality of PEs (e.g., PE 799). In some embodiments, one or more peripheral portions of the PEs are coupled to I/O 720A. For example, a first ASIC may include a column-organized section of PEs, and a second ASIC may include a square-organized section or a rectangular-organized section of PEs. Other organizations of ASICs on the substrate 712 are included herein.

In some embodiments, model layers (e.g., network nodes associated with layers in a neural network) may be assigned to PE 799 elements in a left-to-right and/or an upper-to-lower fashion, with earlier layers (e.g., an input layer) on the left and/or upper ends and subsequent layers (e.g., an output layer) on the right and/or lower ends. Accordingly, data flow may be arranged between adjacent processing regions to follow a processing sequence such as a sequence of model layers.

In some embodiments, determining one or more processing regions include scaling (e.g., up or down) compute capacity and storage capacity in tandem, enabling various price/performance implementations. For example, 700 PEs may be allocated for a processing region along the X direction, and 700 PEs may be allocated for the processing region along the Y direction, with 490,000 PEs overall allocated to the processing region. For example, 1750 PEs may be allocated for a processing region along the X direction, and 1800 PEs may be allocated for the processing region along the Y direction, with 3,150,000 PEs overall allocated to the processing region.

In some embodiments, the substrate 712 comprises any one or more of a rack-width substrate, an entire wafer, a substantial portion of a wafer, a single ASIC, a plurality of ASICs, a plurality of dice, a plurality of 3D-stacked dice, and a PCB comprising one or more of the foregoing. For a first example, the substrate 712 may comprise a portion of a wafer corresponding to a largest rectangle, according to physical granularity of the PEs, fitting inside an entire substantially circular wafer. For a second example, the substrate 712 comprises N-by-M ASICs coupled via a PCB, each ASIC comprising A-by-B PEs. In this second example, the substrate may include N times A times M times B number of PEs.

In some embodiments, the compute accelerator 700 may include an array of processing regions including one or more PEs and/or one or more memories (e.g., high-bandwidth memory (HBM) or other types of memory). In some embodiments, a processing region may include any type of memory (e.g., DRAM, SRAM, etc.) arranged proximate to the compute elements. In some embodiments, some formats of data packets communicated via the couplings between PEs 799 may include a packet payload, an indicator, and/or an instruction. In some embodiments, a plurality of PEs may be arranged as a PE cluster, each PE cluster including at least one memory (e.g., a memory stack, high-bandwidth memory, DRAM, etc.). A PE cluster may include any one or more of an entire wafer, a portion of a wafer, a single ASIC, a plurality of ASICs, a plurality of dice, a plurality of 3D-stacked dice, a plurality of 2.5D-stacked dice, and a PCB comprising one or more of the foregoing.

In some embodiments, data packets are communicated relatively more in parallel between PEs of a PE cluster than between PE clusters. For example, the couplings between PE 799 elements may enable communication of an entire data packet in a single clock cycle via a parallel transfer of a plurality of bits on a plurality of physical wires. For example, the couplings between the PE clusters may enable communication of a data packet over a plurality of clock cycles via a serial transfer of the bits of the data packet. In some embodiments, the clock for the parallel transfer and the clock for the serial transfer are multiples of each other so that bandwidth of the parallel transfer and the serial transfer are substantially identical, or alternatively an integer multiple of one another.

In some embodiments, a PE cluster include memory implemented with one or more memory dies (e.g., DRAM dies) and/or a memory controller die. The PE cluster may be stacked by 3D-stacking the PE dies, the memory dies, and/or the memory controller die. In some embodiments, a PE cluster may be stacked by 2.5D-stacking the PE dies, the memory dies, and/or the memory controller die to an interposer. In some embodiments, memory dies may include storage via dynamic storage cells.

In some embodiments, local memory (e.g., 48 KB) of each PE may be used to store instructions and data, such as parameters and activations. The instructions and/or data are paged in and out of the local memory of each PE from and to the non-local memory under control of software executing on the respective PE, thus using the local memories as software managed caches for the PEs.

In some embodiments, PEs of the compute accelerator 700 are conceptually partitioned into compute, storage, and/or delivery roles by configuring and/or programming such that a fraction of the PEs substantially or entirely perform computation tasks and the remainder of the PEs substantially or entirely perform storage tasks (e.g., operand storage) and/or perform data delivery tasks.

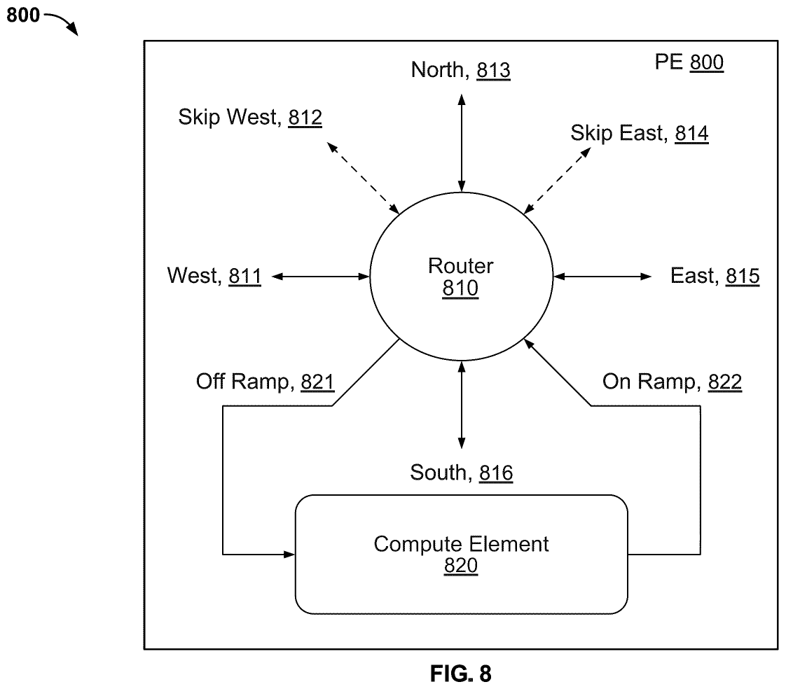

At FIG. 7, a compute accelerator may include a plurality of PEs coupled to each other via a fabric. Each PE may include at least one compute element (CE) (e.g., for performing computations), local memory, and/or a router (e.g., for managing and/or implementing movement of information on the fabric) as described in detail with respect to FIG. 8.

The fabric operates as a communication interconnect between most or all of the PEs in the compute accelerator(s). The fabric transfers data packets, e.g., via physical couplings, to enable transfer of an entire data packet per cycle (e.g., core clock cycle). In some aspects, the fabric may be a local interconnect distributed throughput the PEs such that each PE is enabled to communicate directly with its (physical) neighbors. Communication to other-than (physical) neighbors is via hops through intermediate nodes, e.g., others of the PEs. In some embodiments, a distributed local fabric topology efficiently maps to a model (e.g., neural network) workload (e.g., each layer sends data to a neighboring layer) and/or is implementable with relatively lower cost in hardware.

For example, at FIG. 7, a (physical) fabric topology may include a 2D mesh with each hop in the X or Y dimension (e.g., West 811 or North 813 of FIG. 8, respectively) performed in a single core clock cycle. In some embodiments, a PE may include skip connections (e.g., Skip West 812 of FIG. 8) and/or loop connections. In some embodiments, an example skip connection enables PEs in a same row of the 2D mesh and physically separated by a number of other PEs to communicate with each other as if the PEs were physically adjacent. For example, a hop along a skip connection (e.g. Skip West 812 of FIG. 8) is performed in a single core clock cycle. In some embodiments, an example loop connection enables a PE at the bottom of a column of PEs to communicate with a PE at the top of the column as if the PEs were physically adjacent. In some embodiments, a hop along a loop connection is performed in a single core clock cycle.

In some embodiments, performing each hop in the X or Y dimension in a single clock enables simplifying implementation of arbitrary programmable routing topologies and related timing constraints. In some circumstances, the single cycle per hop latency is compatible with an associated pipelined data flow pattern. In some circumstances (e.g., when communicating from one layer to a next layer), the single cycle per hop latency adds additional latency and reduces performance. The additional latency is worst when the layer is deep and uses many PEs, since more hops are used to escape the layer and to reach all the PEs of the next layer. The additional latency results in overall workload pipeline length increasing and therefore storage (e.g. for forward pass activations) increasing.

The skip connections may be used to reduce the additional latency. For example, each skip connection may skip 50 PEs in a single core clock cycle. The latency to enter the first skip connection is 49 hops maximum. The latency to reach a final PE after exiting a final skip connection is 49 hops maximum. Then, there is a 98-core clock cycle maximum latency overhead and a 49-core clock cycle average latency overhead. The latency to process a layer is 2000 core clock cycles. In this example, there is a 5% maximum overall overhead and a 2.5% average overall overhead.

In some embodiments, each row has skip connections and each column has loop connections. In some embodiments, each skip connection skips 50 PEs, and each column has 200 PEs that a loop connection encompasses. In some embodiments, a single loop connection (e.g., in a context of a column of PEs, between the PE at the bottom of the column and the PE at the top of the column) approximately physically spans the column, and in other embodiments, loop connections of the column are physically implemented by folding so that the average and worst case loop hops approximately physically span two PEs.

FIG. 8 depicts a block diagram illustrating an example PE 800 and some components thereof. PE 800 includes Router 810 and Compute Element 820. Router 810 selectively and/or conditionally communicates (e.g. transmits and receives) data packets between other PEs (e.g., logically adjacent and/or physically adjacent PEs) and PE 800 via couplings 811-816. Couplings 811-816 are illustrated as bidirectional arrows to emphasize the bidirectional communication of data packets on the couplings. Backpressure information is also transmitted on the couplings in the reverse direction of packet information the backpressure corresponds to. Router 810 selectively and/or conditionally communicates data packets to PE 800 (e.g., Compute Element 820) via Off Ramp 821 and communicates data packets from PE 800 (e.g., Compute Element 820) via On Ramp 822. Off Ramp 821 is illustrated as a unidirectional arrow to emphasize the unidirectional communication of data packets on the coupling (e.g., from Router 810 to Compute Element 820). Backpressure information is also transmitted on the coupling in the reverse direction of packet information (e.g. from Compute Element 820 to Router 810). On Ramp 822 is illustrated as a unidirectional arrow to emphasize the unidirectional communication of data packets on the coupling (e.g., from Compute Element 820 to Router 810). Backpressure information is also transmitted on the coupling in the reverse direction of packet information (e.g. from Router 810 to Compute Element 820).

Compute Element 820 performs computations on data embodied in the data packets according to instruction address information derivable from the data packets. The instruction address information is used to identify starting addresses of tasks embodied as instructions stored in storage (e.g., any one or more of memory, cache, and register file(s)) of the compute element. Results of the computations are selectively and/or conditionally stored in the storage and/or provided as data embodied in data packets communicated to the router for, e.g., transmission to the other PEs and or PE 800.

Router 810 selectively and/or conditionally communicates (e.g. transmits and receives) backpressure information between the other PEs and PE 800 via couplings 811-816. Router 810 selectively and/or conditionally transmits backpressure information to PE 800 via On Ramp 822. Router 810 receives backpressure information from PE 800 via Off Ramp 821. The backpressure information provided to the other PEs, as well as the backpressure information provided to PE 800, is used by the other PEs and PE 800 to stall transmitting data (e.g., packets) that would otherwise be lost due to insufficient queue space to store the data in Router 810. The backpressure information received from the other PEs and PE 800 is used respectively by Router 810 to prevent transmitting data (e.g., packets) that would otherwise be lost due respectively to insufficient queue space in the routers of the other PEs and insufficient space in input queues of

### Compute Element 820.

In various embodiments, any one or more of 811-816 are omitted.

In some embodiments and/or usage scenarios, PE 800 is an embodiment of PE 799, and/or elements of PE 800 correspond to an implementation of PE 799. In some embodiments, North 813, East 815, South 816, and West 811 correspond respectively to North coupling 730, East coupling 731, South coupling 732, and West coupling 733.

FIG. 9 depicts an example layout 900 including placement of processing regions 904-906 at a compute accelerator and routing paths therebetween, in accordance with some embodiments of this disclosure. At FIG. 9, the layout 900 may include a reference origin ((x₀, y₀) 902). The compute accelerator may include a fabric of a rectangular region of extent (Δx, Δy), whose PEs implement a model layer. In some embodiments, processing regions (e.g., PR 904, 906) are sized to balance resources to load, shaped to improve compute efficiency, and/or placed to form effective routing paths. The locations on the region's edges of the model's input and output ports may be selected.

A route (e.g., including path 910 from start 908 to end 912) may be determined between the PRs 904-906 based on connection in a model, e.g., by each of the nets constituting a bus that conveys tensor data to the layers that consume it. A path is specified for each net of the bus, where a path is a starting (x₀, y₀) point and an ordered list of cardinal directions (N, E, S, W) that trace the links used along the path. The route may include multicast paths, as a tensor may be consumed by more than one subsequent model. In some embodiments, heuristics, such as one based on the solution of a single source shortest path problem, solve these problems well. An alternate version modifies the graph edge weights to reflect the current (due to already-routed busses) sharing of bandwidth in regions of the fabric to bias the shortest path routing to use less congested areas. For example, one or more PEs at the start 908 may be configured for routing data packets via PEs along the path 910 to PEs of the PR 906 at the end 912.

In some embodiments, arranging connection between processing regions includes assigning one or more virtual channel identifiers, e.g., by assigning virtual channel identifiers to nets, optionally and/or selectively with changes to alternate virtual channel identifiers along the route. The nets coming into a given core/router may have different virtual channel identifiers, leading to a graph routing problem solvable with heuristics.

FIG. 10 depicts an example tree diagram and layout including placement of processing regions at a compute accelerator, in accordance with some embodiments of this disclosure. In some embodiments, processing regions of one or more compute accelerators are determined, e.g., by assigning non-overlapping regions such as rectangular regions or other shaped regions to each model layer of a model. For example, a region of fabric area to each model layer is identified that is proportional to the number of floating-point operations (FLOPs) for the processing. In some embodiments, input to placing processing regions may include a collection of nodes. Each node may indicate a number of FLOPs it is required to perform (e.g., normalized to a per-input basis). The node may provide a monotonically decreasing effective utilization function, u_{A}(Δx, Δy). For example, placement constraints may be expressible as a binary tree such as a tree diagram having nodes 1002-1006 with model layers represented by leaf nodes. Internal nodes in the tree express the requirement that nodes in each branch is to be separable either by a horizontal partition or by a vertical partition. In some aspects, the tree is a binary space partition (BSP) with all internal nodes using only orthogonal partitions, and each tree corresponds to a placement.

As an illustrative example, the layer placement starts by first determining the estimated relative area that each layer should be assigned. This is performed by first calculating:

$$Area = ( Fundamental FLOPs ) / ( Estimated Utilization )$$

and then normalizing by total area. Assigning coordinates to each partition is performed with two passes over the tree, e.g., by first summing relative areas and recording in interior nodes and by secondly determining partition coordinates based on the relative area of each branch. In some embodiments, the relative areas may be updated based on the utilization function. For example, the placement process may iterate using the revised relative areas to incrementally adjust the placement. In some embodiments, placing the processing regions includes searching over nodes of a binary tree such as the nodes 1002-1006.

For example, a score may assigned to each placement indicating the weighted utilization of the entire network:

$${\sum }_{A ϵ Node} {F}_{A} {u}_{A}$$

Elementary mutations, such as swapping and flipping, are defined on a tree. Swapping corresponds to swapping any two nodes (internal or leaf) with each-other. Flipping corresponds to flipping the orientation of an internal node from horizontal to vertical, or vice versa.

Thus, starting from a binary tree with n leaves, all binary trees with n leaves are generatable by an appropriate sequence of elementary mutations.

Then simulated annealing is performed using the score function as an energy landscape, and the mutation function to select neighbors. The annealing process is modified to enable a population of several candidate solutions. Conceptually similar to a genetic algorithm, the population of candidates enables pruning of a bad solution in favor of multiple descendants of a good solution. However, unlike a genetic algorithm, the software stack performs no cross-over mutations.

In some embodiments, placing the processing regions may include modifying a placement to produce a layout that is easier to route. Information about layer connectivity is received and layer positioning is optimized to bring layers that communicate with each other close together. For example, the PR 1008 may be determined to have a X-direction length 1010 and a Y-direction height 1012 based on the node 1006.

In some embodiments, mapping the regions and associated decoders may include optimizing one or more region parameters, such as size and shape of a region, to balance one or more computing resource criteria, such as compute, storage, and/or latency or routing bandwidth (e.g., how many processing elements allocated for compute, storage/cache, and/or routing). The criteria may be based on the ML model (e.g., number of weights, layer size, etc.). For example, the PR 1008 may be determined based on the utilization function for the mapped model layer.

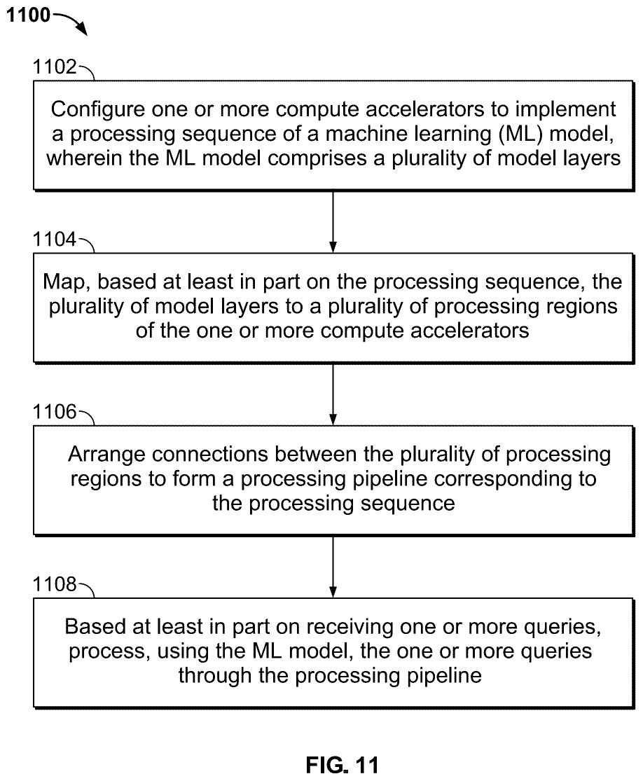

FIG. 11 is a flow diagram of an example process 1100 for inference using a pipeline execution model, in accordance with some embodiments of this disclosure. At block 1102, processing circuitry configures one or more compute accelerators to implement a processing sequence of an ML model. The ML model includes a plurality of model layers. At block 1104, the processing circuitry configures the one or more compute accelerators by mapping, based at least in part on the processing sequence, the plurality of model layers to a plurality of processing regions of the one or more compute accelerators. At block 1106, the processing circuitry configures the one or more compute accelerators by arranging connections between the plurality of processing regions to form a processing pipeline corresponding to the processing sequence. At block 1108, the processing circuitry, based at least in part on receiving one or more queries, processes, using the ML model, the one or more queries through the processing pipeline.

As an illustrative example, a neural network model is identified. Processing circuitry determines a sequence of network layers of the model. The processing circuitry may determine placement of processing regions at one or more compute accelerators based on the amount of compute and memory for executing each layer, e.g., as described with respect to FIGS. 9-10. The processing circuitry maps each layer to one or more processing regions and stores, in memory at the processing region(s), the parameters (e.g., weights, etc.) for the mapped layer. The processing circuitry may determine one or more routing paths in the processing regions and/or between processing regions, e.g., as described with respect to FIG. 9. The processing circuitry arranges the connections to form a pipeline execution model. The processing circuitry may receive one or more prompts (e.g., via user input) and processes the received prompts using the pipeline.

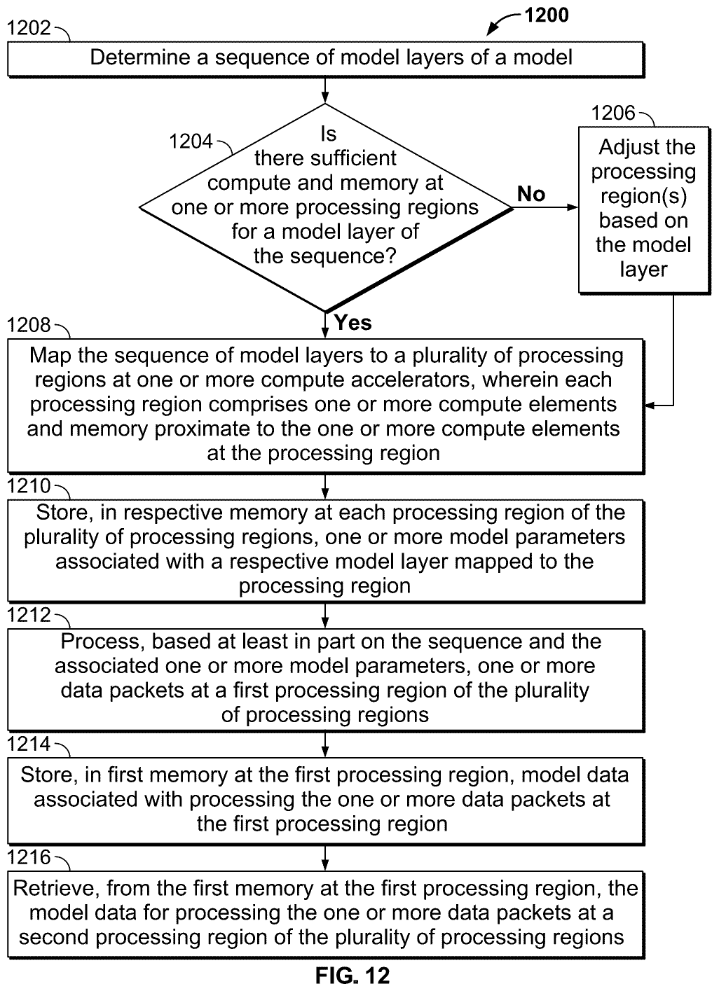

FIG. 12 is a flow diagram of an example process 1200 for processing data using a model including storing model parameters and/or model data in memory proximate to the compute, in accordance with some embodiments of this disclosure. At block 1202, processing circuitry determines a sequence of model layers of a model. At block 1204, the processing circuitry may determine whether there is sufficient compute and/or memory at a processing region for a model layer. For example, the processing circuitry may determine the number of FLOPs for each model layer and calculate the area as described with respect to FIGS. 9-10. If there is insufficient compute and/or memory, the processing circuitry may update the processing region(s) at block 1206 and continue to block 1208. If there is sufficient compute and/or memory, the processing circuitry may continue to block 1208. At block 1208, the processing circuitry maps the sequence of model layers to the processing regions at one or more compute accelerators. Each processing region may include one or more compute elements and memory proximate to the one or more compute elements. At block 1210, the processing circuitry may store, in respective memory at each processing region, one or more model parameters for executing a model layer that is mapped to the processing region.

At block 1212, the processing circuitry may process, based at least in part on the sequence and the associated one or more model parameters, one or more data packets, e.g., at a first processing region. At block 1214, the processing circuitry stores, in first memory at the first processing region, model data associated with processing the one or more data packets at the first processing region. At block 1216, the processing circuitry retrieves, from the first memory at the first processing region, the model data for processing the one or more data packets at a second processing region. For example, the first processing region may be adjacent to the second processing region. The model data may be retrieved via routing PEs at one or both of the processing regions.

It is noted and appreciated that the discussed examples herein are intended to be illustrative and non-exhaustive. Other embodiments, combinations, and/or variants thereof enabled by the pipeline architecture and the near-compute memory bandwidth of the one or more compute accelerators described herein are included in the principles set forth by the present disclosure.

The methods, systems, apparatuses, etc., discussed herein are intended to be illustrative and non-limiting. One skilled in the art would appreciate that the parts of the methods, systems, apparatuses, etc., discussed herein may be omitted, modified, combined and/or rearranged, and any additional parts may be included, and/or any additional steps may be performed without departing from the scope of the present disclosure. More generally, the above disclosure is meant to be illustrative and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. It should also be noted that the systems and/or methods described above may be applied to, or used in accordance with, other systems and/or methods. Throughout the specification the phrases “in response to,” “based on,” and “based at least in part on” shall be understood to have a broad meaning unless context requires otherwise. For example, “in response to” can refer to a step that is in direct or indirect response to a prior step, and “based on” can refer to a step that is based at least in part on a prior step.

1. A method comprising:
configuring one or more compute accelerators to implement a processing sequence of a machine learning (ML) model, wherein the ML model comprises a plurality of model layers, and wherein the configuring comprises:
mapping, based at least in part on the processing sequence, the plurality of model layers to a plurality of processing regions of the one or more compute accelerators; and
arranging connections between the plurality of processing regions to form a processing pipeline corresponding to the processing sequence; and
based at least in part on receiving one or more queries, processing, using the ML model, the one or more queries through the processing pipeline.

2. The method of claim 1, wherein each processing region of the plurality of processing regions comprises a respective plurality of processing elements, and wherein each processing element of the respective plurality of processing elements comprises one or more compute elements and memory positioned proximate to the one or more compute elements.

3. The method of claim 2, wherein the one or more compute accelerators comprise a fabric, wherein the fabric is to connect processing elements of the plurality of processing regions, wherein each processing element of the respective plurality of processing elements comprises a router coupled to the fabric, and wherein the arranging the connections comprises arranging fabric elements of the fabric to connect adjacent processing elements of the plurality of processing regions.

4. The method of claim 1, wherein a first compute accelerator, of the one or more compute accelerators, comprises one or more processing regions, of the plurality of processing regions, disposed at a substantially whole substrate.

5. The method of claim 1, wherein the mapping comprises mapping successive model layers of the processing sequence to adjacent processing regions of the plurality of processing regions.

6. The method of claim 1, wherein a first processing region of a first compute accelerator is adjacent to a second processing region of a second compute accelerator, and wherein the arranging the connections comprises:
identifying, at the first processing region, one or more processing elements neighboring the second processing region; and
configuring one or more local communication paths between the one or more identified processing elements and the second processing region.

7. The method of claim 6, further comprising retrieving, from local memory of the first processing region via the one or more local communication paths, model data for processing the one or more queries at the second processing region.

8. The method of claim 1, wherein the processing, using the ML model, the one or more queries comprises:
determining, based on the one or more queries, a respective sequence of tokens;
generating, at a respective processing region, model data associated with the respective sequence of tokens using a respective model layer; and
storing, in local memory of the respective processing region, the model data.

9. The method of claim 1, further comprising:
mapping a de-embedding layer associated with the ML model to a last processing region of the plurality of processing regions for the processing pipeline; and
generating model output using the de-embedding layer.

10. The method of claim 1, wherein the ML model is a target model, and wherein the plurality of model layers is a first plurality of model layers, the method further comprising:
determining, based at least in part on the target model, a second plurality of model layers of a draft model;
mapping the second plurality of model layers to the plurality of processing regions;
determining one or more draft tokens by processing, using the draft model concurrently with using the target model, the one or more queries through the processing pipeline; and
validating, using the target model, the one or more draft tokens.

11. A system comprising:
one or more compute accelerators comprising a plurality of processing regions; and
processing circuitry to:
configure the one or more compute accelerators to implement a processing sequence of a machine learning (ML) model, wherein the ML model comprises a plurality of model layers, and wherein the configuring comprises:
map, based at least in part on the processing sequence, the plurality of model layers to the plurality of processing regions of the one or more compute accelerators; and
arrange connections between the plurality of processing regions to form a processing pipeline corresponding to the processing sequence; and
based at least in part on receiving one or more queries, process, using the ML model, the one or more queries through the processing pipeline.

12. The system of claim 11, wherein each processing region of the plurality of processing regions comprises a respective plurality of processing elements, and wherein each processing element of the respective plurality of processing elements comprises one or more compute elements and memory positioned proximate to the one or more compute elements.

13. The system of claim 12, wherein the one or more compute accelerators comprise one or more fabrics, wherein the one or more fabrics is to connect processing elements of the plurality of processing regions, wherein each processing element of the respective plurality of processing elements comprises a router coupled to the fabric, and wherein the processing circuitry is further to arrange fabric elements of the one or more fabrics to connect adjacent processing elements of the plurality of processing regions.

14. The system of claim 11, wherein a first compute accelerator, of the one or more compute accelerators, comprises one or more processing regions, of the plurality of processing regions, disposed at a substantially whole substrate.

15. The system of claim 11, wherein the processing circuitry is to map successive model layers of the processing sequence to adjacent processing regions of the plurality of processing regions.

16. The system of claim 11, wherein a first processing region of a first compute accelerator is adjacent to a second processing region of a second compute accelerator, and wherein the processing circuitry is arrange the connections by:
identifying, at the first processing region, one or more processing elements neighboring the second processing region; and
configuring one or more local communication paths between the one or more identified processing elements and the second processing region.

17. The system of claim 16, wherein the processing circuitry is further to retrieve, from local memory of the first processing region via the one or more local communication paths, model data for processing the one or more queries at the second processing region.

18. The system of claim 11, wherein the processing circuitry is to process, using the ML model, the one or more queries by:
determining, based on the one or more queries, a respective sequence of tokens;
generating, at a respective processing region, model data associated with the respective sequence of tokens using a respective model layer; and
storing, in local memory of the respective processing region, the model data.

19. The system of claim 11, wherein the processing circuitry is further to:
map a de-embedding layer associated with the ML model to a last processing region of the plurality of processing regions for the processing pipeline; and
generate model output using the de-embedding layer.

20. The system of claim 11, wherein the ML model is a target model, wherein the plurality of model layers is a first plurality of model layers, and wherein the processing circuitry is further to:
determine, based at least in part on the target model, a second plurality of model layers of a draft model;
map the second plurality of model layers to the plurality of processing regions;
determine one or more draft tokens by processing, using the draft model concurrently with using the target model, the one or more queries through the processing pipeline; and
validate, using the target model, the one or more draft tokens.

21-30. (canceled)
